(19) United States
(12) Patent Application Publication
(10) Pub. No.: US 2014/0244218 A1
(43) Pub. Date: Aug. 28, 2014

(54) ARCHITECTURE OPTIMIZATION

(71) Applicant: INTERNATIONAL BUSINESS MACHINES CORPORATION, Armonk, NY (US)

(72) Inventors: Lev Greenberg, Haifa (IL); Michael Masin, Haifa (IL)

(73) Assignee: INTERNATIONAL BUSINESS MACHINES CORPORATION, Armonk, NY (US)

(21) Appl. No.: 13/775,272

(22) Filed: Feb. 25, 2013

(51) Int. Cl. G06F 17/50

(52) U.S. Cl. CPC G06F 17/5004
USPC 703/1

(57) ABSTRACT

A computerized method, system and computer product for automatic architecture generation is disclosed. The computerized method includes receiving a functional description of an architecture of a system, wherein the system architecture includes a plurality of functions and a plurality of functional links between the functions, receiving or defining at least one functional failure case and its maximum allowed failure probability, defining an algebraic function approximating the probability of occurrence of each failure case, automatically generating an optimized architecture using an optimization solver wherein all architecture's one approximated failure probabilities are smaller than the maximum allowed probability for the respective failure cases and outputting the automatically generated architecture.

### BACKGROUND

The present invention, in some embodiments thereof, relates to architecture design safety and reliability and, more specifically, but not exclusively, to a computerized method for safe and reliable automatic architecture generation.

A recent trend in systems engineering is automatic architecture optimization. Complex system architectures are hard to optimize by traditional trial-and-error methods. This can be alleviated by system architecture optimization techniques where system engineers define boundaries for the design space and an optimization solver calculates the optimal solution automatically. However, if safety and reliability requirements are not considered during the automatic system architecture generation, given the high impact of safety on systems design, addressing safety requirements in later stages becomes either impossible or very expensive.

Traditional reliability calculations are rather operational than denotational, i.e., they define a procedure to calculate failure probabilities for a given system architecture. Denotational calculus defines a set of constraints depending on the architectural decision variables where the resulting failure probability is derived “algebraically” from the constraints. A major difficulty with reliability calculations is that it is combinatorial and highly non-linear. For example, Bauer, C., et. al. in “Flight-control system architecture optimization for fly-by-wire airliners”, Journal of Guidance Control and Dynamics, Vol. 30, no. 4, pp. 1023-1029, AIAA (2007), presented an approach for architecture optimization for aircraft roll systems. The design problem of a flight-control system on a large fly-by-wire airliner is to find combinations of actuator(s), power circuit(s), computer(s) for each movable surface, so as to fulfill the constraints imposed by the safety regulations, while keeping the resulting system weight as low as possible. The authors used a black-box function for the safety assessment of potential solutions. The black-box function provides an accurate evaluation of the safety requirements but the calculation was rather costly, so the optimization algorithm had to be limited to “black-box in the loop” methods and the safety assessment was not done for all possible architectures.

If safety and reliability requirements are not considered during automatic architecture generation, given the high impact of safety on systems design, there is a high probability that the optimized system architectures will not meet the safety and reliability requirements. Therefore, it is critical to model and take into account reliability and safety requirements during Design Space Exploration (DSE) in early architectural stages.

### SUMMARY

According to an aspect of some embodiments of the present invention there is provided a computerized method for automatic architecture generation. The computerized method includes receiving a functional and physical description of architecture of a system. The functional description includes a plurality of functions and a plurality of functional links between the plurality of functions. The computerized method includes defining at least one functional failure case and a maximum allowed failure probability for the at least one functional failure case. The computerized method includes defining an algebraic function approximating the probability of occurrence of the at least one functional failure case. The computerized method includes automatically generating an architecture having an approximated failure probability which is smaller than the maximum allowed at least one failure probability using the algebraic function and outputting the automatically generated architecture.

According to a further feature of an embodiment of the present invention, a computerized method for automatic architecture generation is provided. The computerized method includes receiving a functional description of an architecture of a system, the functional description includes a plurality of implemented functions and a plurality of functional links between the plurality of implemented functions. The computerized method includes receiving safety requirements comprising a plurality of functional failure cases and maximum allowed failure probabilities for the plurality of functional failure cases. The computerized method includes defining a set of equations using an algebraic function approximating the probability of occurrence of the plurality of functional failure cases and defining a system of algebraic constraints. The computerized method includes generating a set of equations of algebraic failure probabilities using an algebraic function approximating the probability of occurrence of the plurality of functional failure cases and the system of algebraic constraints. The computerized method includes automatically generating an architecture having approximated failure probabilities which are smaller than the maximum allowed failure probabilities using an optimization solver that solves the set of equations and outputting the automatically generated architecture.

According to a further feature of an embodiment of the present invention, a computerized system for automatic architecture generation is provided. The computerized system includes an input interface which receives a functional description of an architecture of a system, the functional description includes a plurality of functions and a plurality of functional links between the plurality of functions and safety requirements comprising at least one maximum allowed failure probability. The computerized system includes a storage medium for storing the received functional description, the safety requirements and a program code. The computerized system includes a processor for executing the program code, wherein the processor is programmed to receive the functional description of an architecture, to calculate an algebraic function approximating the probability of occurrence of at least one failure case, to automatically generate an architecture having an approximated failure probability which is smaller than the maximum allowed at least one failure probability using the algebraic function and to output the generated architecture.

According to a further feature of an embodiment of the present invention, a computer program product for automatic architecture generation is provided. The computer program product includes a computer readable storage medium. The computer program product includes a first program instructions to receive a functional description of an architecture of a system, the functional description includes a plurality of functions and a plurality of virtual links between the plurality of functions and safety requirements comprising a maximum allowed failure probability of at least one functional failure case. The computer program product includes a second program instructions to define an algebraic function approximating the probability of occurrence of the at least one failure case and a system of algebraic constraints and to generate a set of equations of algebraic failure probabilities using said algebraic function and said system of algebraic constraints. The computer program product includes a third program instructions to automatically generate an architecture using an optimization solver program code and to output the generated architecture where the generated architecture's at least one approximated failure probability is smaller than the maximum allowed probability. The program instructions are stored on the computer readable storage medium.

According to a further feature of an embodiment of the present invention, the optimization solver program code is a MILP optimization solver program code.

Additional features and advantages of the invention will become apparent from the following drawings and description.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram illustrating an automatic architecture generation system, according to some embodiments of the present invention;

FIG. 2A is a flowchart of a computerized method for automatic architecture generation, according to some embodiments of the present invention;

FIG. 2B is a flowchart of the algebraic function calculation, according to some embodiments of the present invention;

FIG. 3 is an exemplary system architecture, according to some embodiments of the present invention;

FIG. 4 is a schematic illustration of a networked aircraft system (NAS) exemplary functions and components, according to some embodiments of the present invention;

FIG. 5 is an illustration of NAS failure cases and functional dependencies, according to some embodiments of the present invention;

FIG. 6 is a first example of a NAS architecture, according to some embodiments of the present invention; and

FIG. 7 is a second example of a NAS architecture, according to some embodiments of the present invention.

### DETAILED DESCRIPTION

According to some embodiments of the present invention, methods, systems and computer products for automatic architecture generation are provided. The computerized method receives a functional description of architecture of a system and at least one failure case. The architecture includes one or more functions and one or more virtual links between the functions. The computerized method uses a System of Algebraic Constraints (SAC) that approximates the probability of occurrence of failure cases. The SAC allows automatic generation of a desired architecture that satisfies safety requirements, for example optimal or substantially optimal architecture using optimization solvers.

As used herein, the term architecture design space means all possible architectures of a system that may be designed that generate the functional behavior defined by the received functional description.

The SAC approximates a set of failure cases which are obtained, for example automatically, from systems requirements that include safety requirement(s) and maximum allowed failure probabilities. In such embodiments, an optimization solver may be used to generate the desired optimal architecture solution exploring the architecture design space. The desired architecture solution has failure probabilities smaller than a set of the received maximum values that define the allowed failure probabilities.

The failure cases may be obtained by combining hazard assessment(s) and risk analysis technique(s). Optionally, the analysis allows determining one or more of the following:

(1) The critical system functions, i.e. functions which may cause a hazard when lost or malfunctioning.

(2) The safety requirements for these functions, i.e. the maximum allowed failure probabilities.

(3) The demands, if any, for additional safety functions in order to achieve acceptable levels of risk for the system.

Optionally, additional safety requirements may be added to the functional description for hazard assessments and risk analysis. The additional safety requirements may include attributes such as safety thresholds, a maximum allowed probability for a failure case to occur and/or failure rules, for example one or more functions or components of the system which are identified as failing when a failure case is identified.

The function(s)/component(s) that the failure case is related to serve as a starting point for recursively propagating that failure in the functional architecture. The basic assumption in safety assessment automatic generating tools is that a function fails when one or more of the functions/components that it needs input from fail. Additional modifications on the relation between the failure case and the function allow the definition of how this propagation is done, for example propagation without restrictions, propagation up to a certain depth or no propagation at all.

According to some embodiments of the present invention, the functional description, consisting of functions and data or energy exchanges between the functions via functional links may be mapped to the physical architecture, consisting of components that implement these functions and connectors between these components.

As used herein, the term ‘virtual link’ means a set of components and connectors that “implements” data or energy transfer between the functions. A functional link may be mapped to a virtual link consisting of a number of components and connectors, network switches and cables.

Some embodiments of the present invention enables automatically generating the desired system architecture while taking into account the preliminary system safety assessment. The disclosed method allows taking into account reliability and safety requirements in early architectural design stages.

According to some embodiments of the present invention, mathematical programming, e.g., a mixed integer linear program (MILP), framework is employed to generate the optimal architecture of the system. MILP algorithms are used to find a solution to a set of linear equations with some of variables restricted to be integer.

According to some embodiments of the present invention, finding a desired, optionally optimal, system architecture in a design space is a MILP problem since a decision regarding the addition or the removal of components to an architecture may be represented mathematically by Boolean algebra having a 0 value for removal of components and a 1 value for the addition of the component to the automatically generated architecture.

Thus, the SAC that approximates a failure probability of the architecture, described in greater details below, may be used to define a MILP equations to be solved by a MILP optimization solver and to generate automatically the desired, optionally optimal, architecture.

MILP optimization solvers such as IBM ILOG CPLEX and GUROBI OPTIMIZATION are commercially available optimization software packages that may be used with embodiments of the present invention. However, the present invention is not limited to commercial MILP optimization solvers, or to non-commercial MILP optimization solvers, and other optimization solvers that maximize or minimize an objective function may be used and such commercial or non-commercial optimization solvers are in the scope of the present invention.

The inventors of the disclosed invention tested the method on a pool of representative benchmark problems and found out that the disclosed method, and in particularly the SAC approximating failure probabilities provide highly accurate results compared to other reliability calculations.

As used herein, the term approximate reliability algebraic function means the definition and solution of SAC approximating failure probability of a failure case.

As used herein, the term optimization solver means a software program used to find a solution that minimize or maximize a cost function and hence is referred to as an optimal solution.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

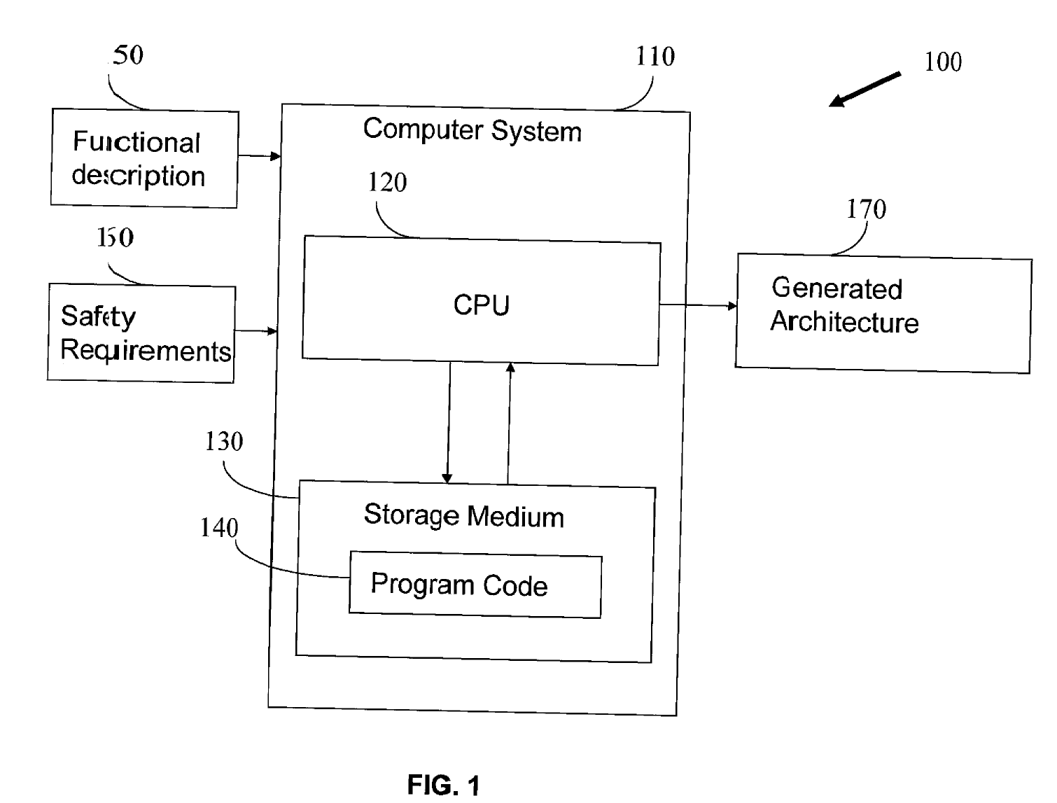

Reference is now made to FIG. 1, which is a block diagram illustrating an automatic architecture generation system, according to some embodiments of the present invention. Computerized system for automatic architecture generation 100 includes a computer system 110 that includes further CPU 120, storage medium 130 used to store program code 140. CPU 120 receives a functional description of an architecture of a system 150 and safety requirements 160. Automatic architecture generation system's 100 CPU 120 is programmed to receive the functional description 150, to receive or define one or more failure case and its maximum allowed probability, to define a SAC approximating the probability of occurrence of the at least one failure case, to automatically generate a desired optimized architecture using an optimization solver. The optimization solver generates an optimized architecture where the approximated failure probability is smaller than the maximum allowed probability. CPU 120 is programmed to output the automatically generated architecture 170.

As argued above, finding a desired, optionally optimal, system architecture in a design space is a MILP problem since a decision regarding the addition or the removal of components to an architecture may be represented mathematically by Boolean algebra having a 0 value for removal of components and a 1 value for the addition of the component to the automatically generated architecture. Accordingly, embodiments of the claimed invention provide a SAC approximating failure probabilities of functional failure cases of the architecture in order to allow using MILP optimization solvers to generate automatically the desired optimal architecture.

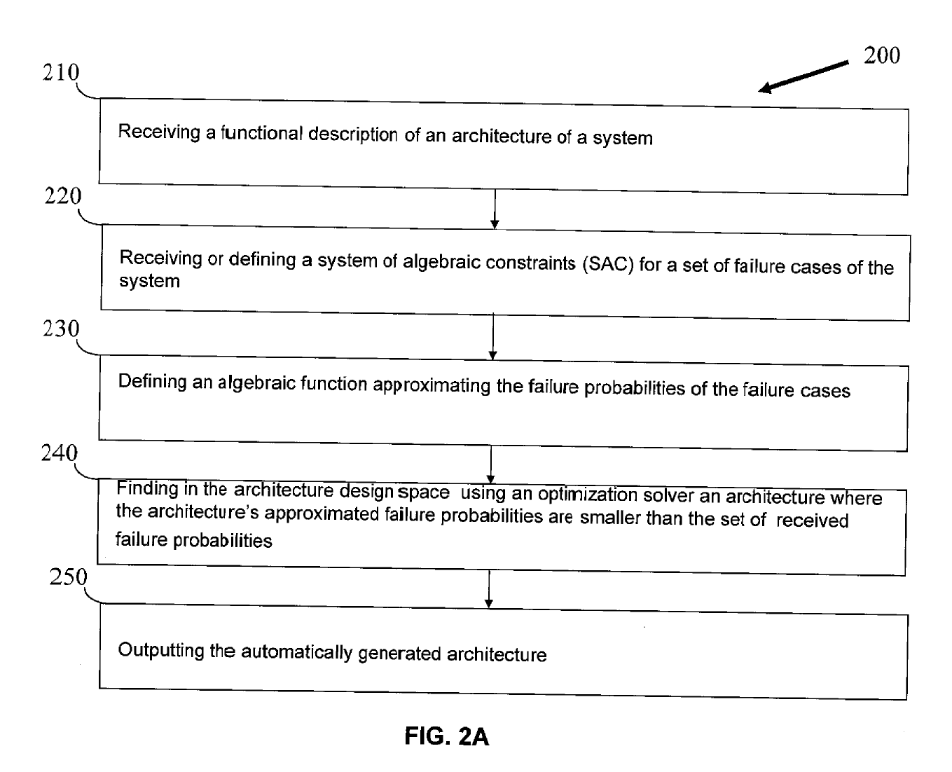

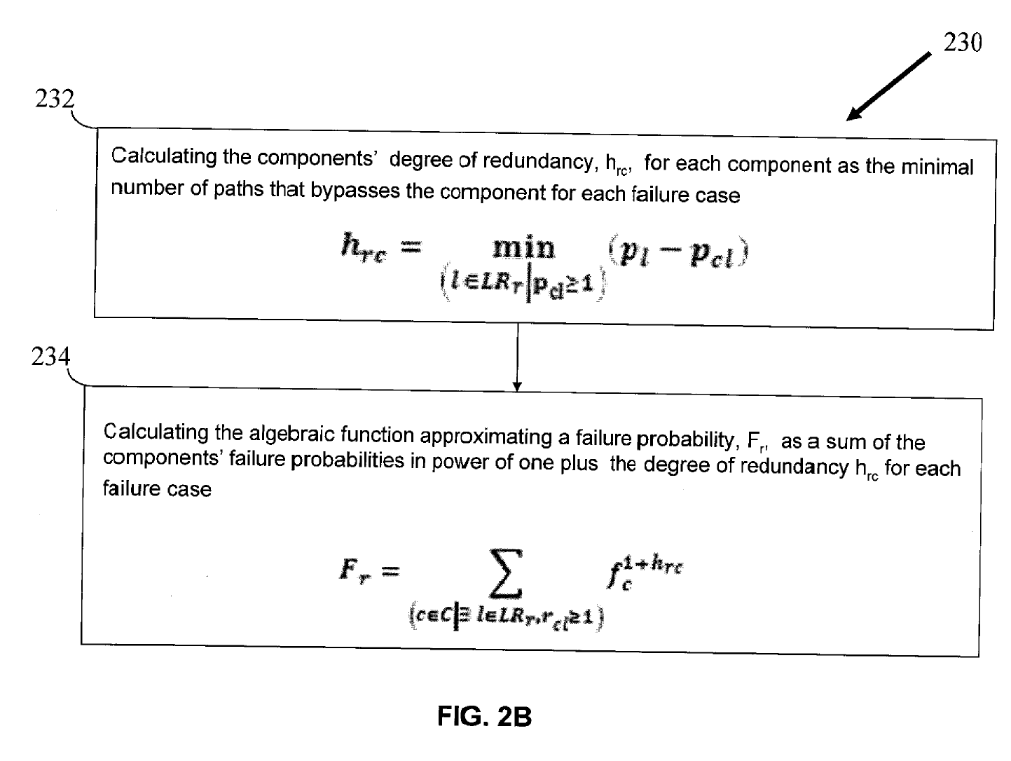

Reference is now made to FIG. 2A, which is a flowchart illustration of a computerized method for automatic architecture generation, according to some embodiments of the present invention. The computerized method for automatic architecture generation 200 starts with receiving a functional description of a system 210 that includes functions and functional links, and possible set of potential architectures including components and connectors, such as network switches and cables, between the architecture components. The architecture may be system architecture of a networked aircraft system, a flight-control system, a sensor-controller-actuator system, a stall recovery system, and/or a chip design system. The architecture may be any model-based system engineering (MBSE) architecture that according to embodiments of the claimed invention may be automatically generated by computerized method 200.

Computerized method 200 continues with receiving or defining a SAC for the received functional description of the system architecture 220. Optionally, the set of failure probabilities, one or more failure probability, may be defined automatically using received failure cases.

The defined SAC 220 may include reliability constraints of one or more component, safety failure constraints of one or more component and/or combinations thereof. Failure of a component may be a complete failure of the component to generate the expected output, generating a wrong output, generating the output with a too long delay, consumption of a higher power than excepted etc.

Computerized method 200 continues with defining a SAC approximating failure probabilities of functional failure cases of architecture 230. Functional failure cases of architecture 230 occur when one or more of the architecture functions and/or components fail. The SAC is defined in FIG. 2B herein below. The SAC enables using optimization solvers to automatically generate the desired architecture as described herein below.

After receiving the functional description 210, receiving or defining a set of failure probabilities for a set of failure cases 220 and defining the algebraic function 230, computerized method 200 continues with automatically generating an architecture using an optimization solver where the generated architecture failure probabilities are smaller than the received or defined set of failure probabilities 240.

Optionally, commercially available MILP optimization solvers such as CPLEX, GUROBI, LINDO and XPRESS-MP may be used. Other Mathematical Programming optimization solvers and other optimization solvers that maximize or minimize an objective function may be used.

MILP optimization solvers solve a linear equation set that includes a received set of constraints; however, other optimization schemes that use other methods to explore the architecture design space and do not solve a set of linear equations may be used to generate automatically the optimal architecture according to computerized method 200.

After generating automatically architecture, having failure probabilities smaller than the received set of failure probabilities 240, computerized method 200 outputs the automatically generated architecture 250.

The inventors of the claimed invention have found that a sum of the architecture components failure probabilities calculated in different powers according to the degree of redundancies of the components may be used as an approximation a failure probability by Mathematical Programming solvers, e.g., MILP optimization solvers. According to embodiments of the claimed invention, the SAC is used to define a set of linear equations solved by the MILP optimization solver. The SAC is described herein below.

Components with high failure probabilities are expected to be the more significant leading terms of the calculated failure probability. Thus, according to some embodiments of the present invention, the SAC described below assigns a critical component, having no redundancy, power of 1, while duplicated redundant components are assigned with higher powers that depend on the degree of redundancy of the components. Note that failure probabilities of components are represented by positive numbers between 0 and 1. Thus, a higher power of a failure probability is a smaller number comparing to the same number in power of 1, meaning that components with higher degree of redundancy contribute less to the calculated failure probability.

The approximate failure function, denoted by Fᵣ, is defined in equations 1 and 2 below. The approximate reliability function variables, describing the redundancy of functions and the corresponding components that implement the functions and/or transfer data between them through input-output functional links, are defined herein below.

Let pₗ be the number of redundant virtual paths for function and/or functional link l and p_{cl} denote a number of redundant virtual paths for function and/or functional link l component c participates. p_{cl} may get the values 0, 1 or pₗ, i.e., component c can either not participate in virtual path l (0), participate just in one path (1) or in all paths (pₗ). With reliable components having no redundancy p_{cl}=pₗ. With unreliable components having redundant components and multiple independent channels p_{cl}=1. Generally, components may participate in more than one virtual paths and less than the total number of redundant virtual paths 1<p_{cl}<pₗ.

h_{rc} denotes the degree of redundancy of component c for reliability requirement r−the minimum number of remaining virtual paths for reliability requirement r in case of failure of component c. h_{rc} is defined in equation 1 below,

$${h}_{rc} = \text{?} ( {p}_{l} - {p}_{cl} ) \\ \text{?} \text{indicates text missing or illegible when filed} \qquad Equation 1$$

Where LRᵣ denotes the set of functions and functional links effecting reliability requirement r.

The approximate failure function, Fᵣ, that denotes the approximation of failure probability for requirement r is

$${F}_{r} = \text{?} {f}_{c}^{1 + {h}_{rc}} \\ \text{?} \text{indicates text missing or illegible when filed} \qquad Equation 2$$

where f_{c} denotes the failure probability of a component c, and C is the set of all components. The reliability requirement used as input to a MILP optimization solver is

Fᵣ≦sᵣRᵣ Equation 3

Where Rr denotes the received maximal allowed failure probability for reliability requirement, sr denotes a safety factor of reliability requirement that strengthens the original requirement Rr to compensate potential “optimism” of the present invention approximate algebraic reliability function. According to some embodiments of the present invention the safety factor, sr, has a lower bound and thus could be set initially to one and then interactively reduced if the optimized architecture does not satisfy requirement r until convergence is achieved. The inventors of the claimed invention have found that sr=1 generates good results with relatively reliable components having small failure probabilities.

Thus, the approximate reliability algebraic function of the present invention, defined in equation 2, replaces complex and nonlinear reliability calculations by a sum over all used components c of components' failure probability in power of one plus remaining redundancy in case of component c failure.

According to some embodiments of the present invention, a MILP set of equations used as input to a MILP optimization solver is given below using auxiliary binary decision variables xrck, where xrck is set to 1 if the component c is selected with redundancy k for a reliability requirement r, and 0 otherwise.

The set of linear equations solved by a MILP optimization solver is given below (one linear equation for each failure case Fr) where kmax is the maximal possible value of k.

$$\text{?} . \\ \text{?} \text{indicates text missing or illegible when filed} \qquad Equation 4$$

Reference is now made to FIG. 2B, which is a flowchart illustration of the algebraic function calculation, according to some embodiments of the present invention. Computerized method 200 step 230 includes calculating the architecture components' degree of redundancy, h_{rc}, for each component as the minimal number of paths that bypasses the component for each failure case 232.

Computerized method 200 step 230 includes calculating the algebraic function approximating a failure probability, Fᵣ, as a sum of the components' failure probabilities in power of one plus the components' degree of redundancy, h_{rc}, for each failure case 234 according to Eqs. 1 and 2 defined herein above.

Computerized method 200 for automatic architecture generation uses the algebraic function approximation 224 for each failure case defined in method step 220 and uses a MILP optimization solver 230 to solve the set of linear equations (Eq. 4 above) and to generate and output the desired optimal architecture.

The approximate reliability algebraic function defined above, Fᵣ, allows using MILP optimization solvers in order to generate the desired optimal architecture. However, other algebraic functions may be used and the present invention is not limited to the specific algebraic function described herein above which is merely an example of an algebraic function that may be used according to embodiments of the present invention.

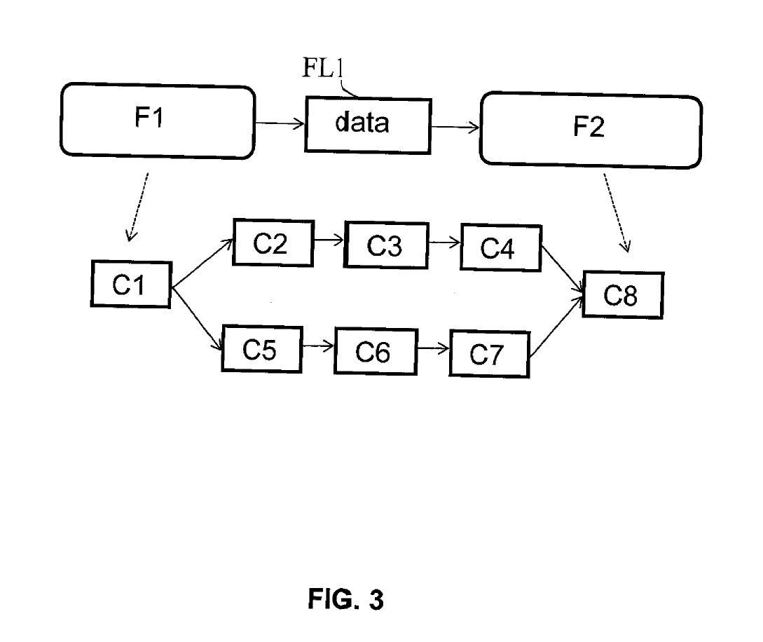

FIGS. 3-7 below illustrate exemplary system architectures and the calculation of the algebraic function for the architectures. The algebraic function calculation is compared with a reference reliability calculation for each system, where the reference calculation is commonly used for system architecture with small failure probabilities.

FIG. 3 is an exemplary system architecture, according to some embodiments of the present invention. Function F1 is an input to function F2 through the functional virtual link FL1. Functions F1 and F2 are implemented, without redundancy, by components C1 and C8. Components C2 to C7 implement the functional virtual link FL1 with redundancy of 2 since there are two independent paths that connect C1 to C8. Therefore, the number of remaining redundant paths the component does not participate in is equal to zero for components C1 and C8 and equal to one for components C2 to C7. Assuming all components have the same small failure probability f, then a reference calculation is equal to 2f+9f². The approximate reliability algebraic function calculation of the present invention using Eqs. 1 and 2 above for FIG. 3 exemplary architecture is

$$\begin{matrix}\text{?} = {f}_{1}^{1 + 0} + \text{?} + \text{?} \\ = 2 f + 6 {f}^{2} .\end{matrix}$$

$$\text{?} \text{indicates text missing or illegible when filed}$$

Both calculations are of the same order of the failure probability and for small f, neglecting the squared terms, both are the same.

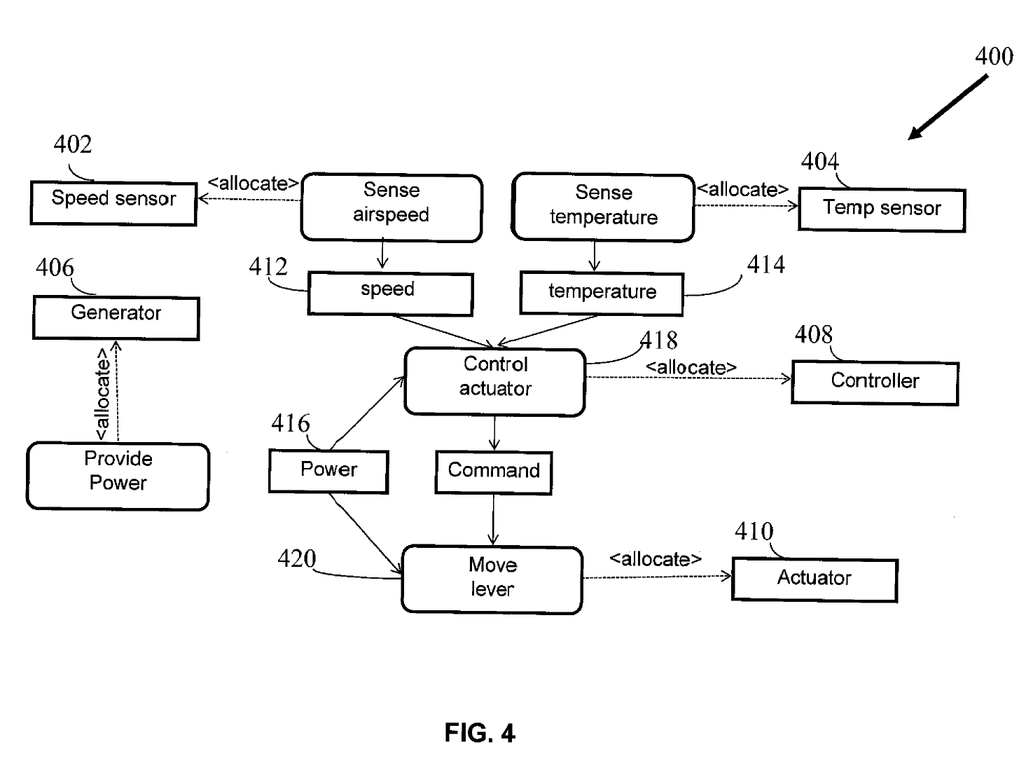

FIG. 4 is a schematic illustration of exemplary functions and components of a networked aircraft system (NAS), according to some embodiments of the present invention. NAS 400 is a representative of current state-of-the-art systems in civil aircraft engineering. Sensors acquire information which is sent via a network to a central controlling application that is hosted on a shared computer. The control outputs of the control application are relayed via the network to actuators.

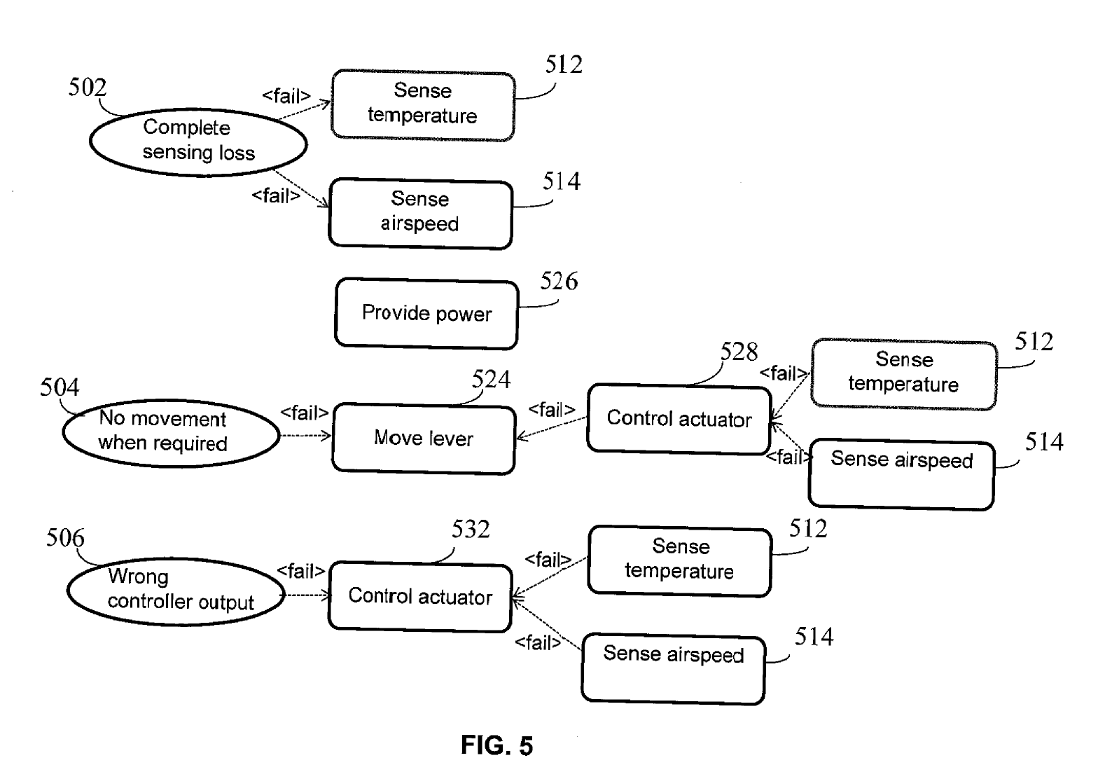

FIG. 4 provides the functional architecture and the allocation of functions to components whereas FIGS. 5, 6 and 7 depict concrete implementations of the NAS including a mapping of the virtual links that connect the components to the network switches. NAS functional description 400 includes airspeed sensor 402, temperature sensor 404, generator 406, controller 408 and actuator 410. NAS functional description 400 describes data and command flows where sensed airspeed 412 and sensed temperature 414 are sampled by controller 408 that processes the data and generates commands 418 to move the aircraft lever 420 using actuator 410. Power supply 416 is provided to NAS 400 by generator 406.

FIG. 5 is an illustration of NAS 400 failure cases and functional dependencies, according to some embodiments of the present invention. Three failure cases are defined for NAS 400: Complete sensing loss 502, no movement when required 504 and wrong controller output 506. Complete sensing loss case failure 502 occurs if airspeed sensor 512 and temperature sensor 514 both fail. No movement when required failure case 504 occurs when the aircraft lever fails to move when required 524. The move lever failure may occur due to power failure 526 or due to failure to control the actuator 528. Failure to control the actuator may occur due to temperature sensing failure 512 or airspeed sensing failure 514. Wrong controller output failure case 506 may occur due to failure to control the actuator 532 which may occur due to a full or partial failure of temperature sensing 512 or airspeed sensing 514.

Note that the three failure cases described in FIG. 5 herein above are only exemplary failure cases and other failure cases may be defined and may be taken into account according to embodiments of the present invention.

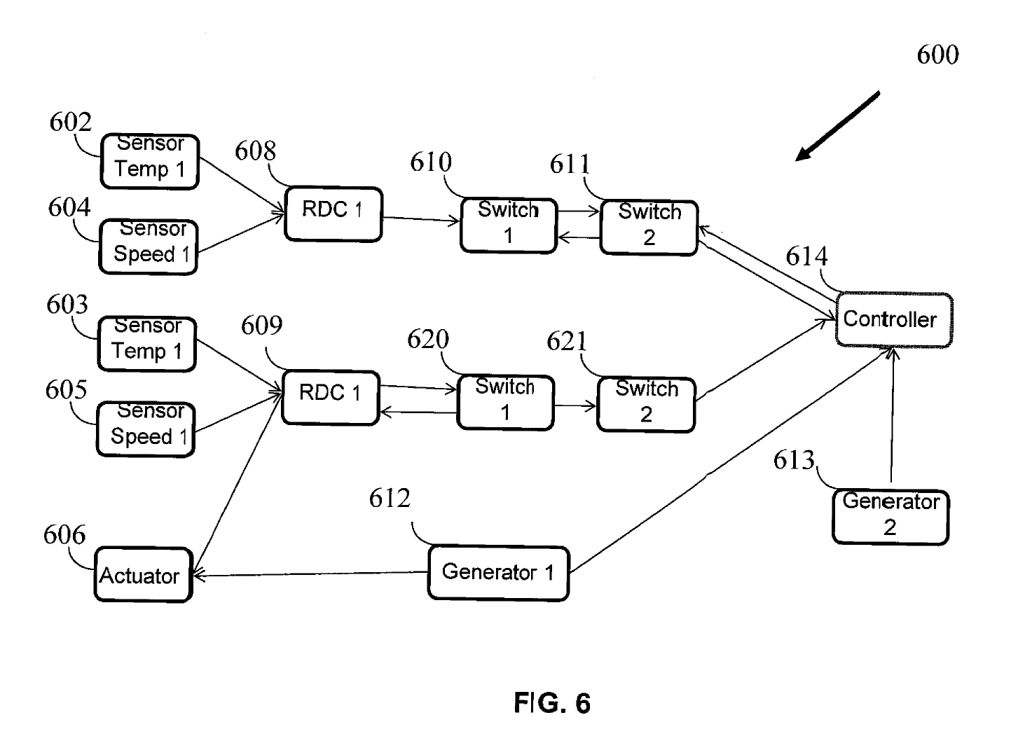

FIG. 6 is a first example of a NAS architecture, according to some embodiments of the present invention. NAS architecture 600 includes two speed sensors 602 and 603, two temperature sensors 604 and 605, an actuator 606, two remote data collectors (RDC) units 608 and 609, four switch units 610, 611, 620 and 621, two generators 612 and 613 and a controller 614. NAS architecture 600 describes data and control flows with redundancies.

Five data and control flows are illustrated in table 640. The first data flow starts at temperature sensor 602, passes through switch 1, 610, and switch 2, 611, and terminates at controller 614. The second data flow starts at speed sensor 604, passes through switch 1, 610, and switch 2, 611, and terminates at controller 614. The third data flow starts temperature sensor 603, pass through switch 3, 620, and switch 4, 621, and terminates at controller 614. The fourth data flow starts at speed sensor 605, passes through switch 3, 620, and switch 4, 621, and terminates at controller 614. The fifth data flow starts at controller 614, passes through switch 1, 610, switch 2, 611, and switch 3, 620 and terminates at actuator 606.

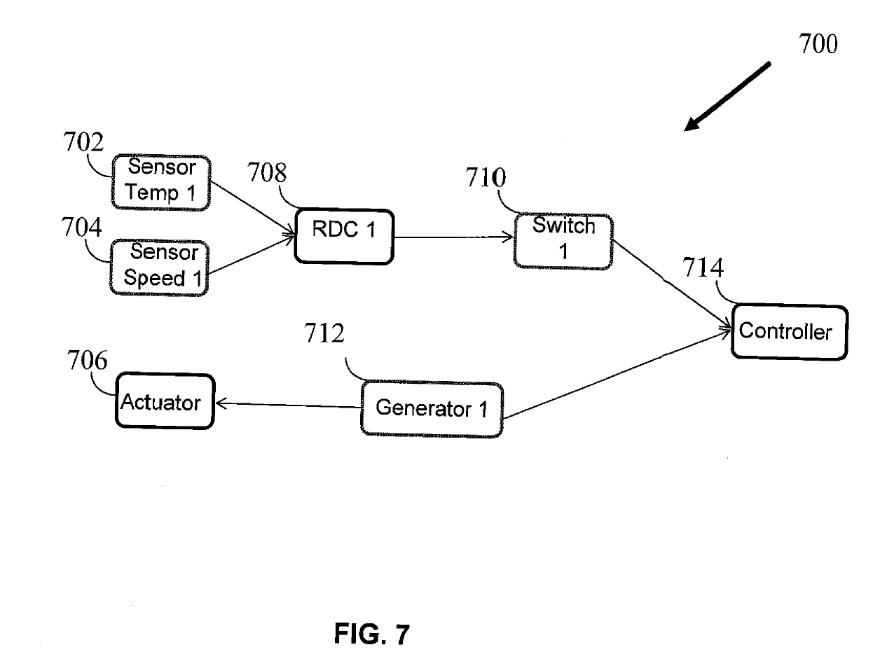

FIG. 7 is a second example of a NAS architecture, according to some embodiments of the present invention. NAS architecture 700 includes only one speed sensor 702, one temperature sensor 704, an actuator 706, one RDC unit 708, one switch unit 710, a generator 712 and a controller 714. NAS architecture 700 describes data and control flows with no redundancy. Three data flows are presented: The first data flow starts at speed sensor 702 pass through RDC1 708 and switch 710 and terminates at controller 714. The second data flow starts at temperature sensor 704 passes through RDC1 708 and switch 710 and terminates at controller 714. The third data flow starts at RDC1 unit 708 and terminates at actuator 706.

NAS architecture 600 includes redundant components (two speed and two temperature sensors) and due to the component redundancies has lower failures probability compared to NAS architecture 700. The present invention computerized method for automatic reliability calculations of all potential architectures outputs the optimal architecture that has failure probabilities matching its reliability requirements.

As described herein above, the computerized method for automatic architecture generation finds in the architecture design space using an optimization solver a desired optimal architecture of the system.

The computerized method uses a MILP optimization solver to automatically generate the desired optimal architecture using SAC for approximating and constraining architecture failure probabilities.

The resulting approximated failure probability is a sum of the components failure probabilities calculated in appropriate powers according to the degree of redundancies of the components.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and computer program products will be developed and the scope of the terms CPU, storage mediums, architectures, components and optimization solvers is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include one or more of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include one or more of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging and/or ranges between” a first indicate number and a second indicate number and “ranging and/or ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method for automatic architecture generation, comprising:
receiving a functional description of an architecture of a system, said functional description comprising a plurality of functions and a plurality of functional links between said plurality of functions;
defining at least one functional failure case and a maximum allowed failure probability for said at least one functional failure case;
defining an algebraic function approximating the probability of occurrence of said at least one functional failure case;
automatically generating an architecture having an approximated failure probability which is smaller than said maximum allowed at least one failure probability using said algebraic function; and
outputting said automatically generated architecture.

2. The computerized method of claim 1, wherein said at least one functional failure case is selected from the group consisting of: reliability failure, safety failure, performance failure and combination thereof.

3. The computerized method of claim 1, wherein said at least one functional failure case is a result of a failure of at least one of said architecture functions.

4. The computerized method of claim 3, wherein said function failure is selected from the group consisting of: a failure to generate an output, generating a wrong output, generating the output with a too long delay, consumption of a higher power than excepted and combinations thereof.

5. The computerized method of claim 1, wherein said automatically generated architecture comprises a physical architecture comprising a plurality of components, which are instances of said plurality of functions and a plurality of connectors, which are instances of said plurality of functional links between said plurality of components.

6. The computerized method of claim 5, wherein said automatically generating comprising mapping said plurality of functions and said functional links of said functional description to said plurality of components and said plurality of connectors of said automatically generated architecture.

7. The computerized method of claim 1, wherein said automatically generating is performed by an optimization solver.

8. The computerized method of claim 6, wherein said optimization solver is a mixed integer linear programming (MILP) optimization solver, wherein said MILP optimization solver solves a set of linear equations using said defined algebraic function and said received at least one failure probability.

9. The computerized method of claim 6, wherein said MILP optimization solver is selected from the group consisting of: CPLEX, GUROBI, LINDO and XPRESS-MP.

10. The computerized method of claim 5, wherein said defined algebraic function is a function of a plurality of failure probabilities of said plurality of components and of the degree of redundancies of said components for said at least one functional failure case, wherein the degree of redundancies of components are calculated as the minimum number of paths bypassing said components performing said at least one functional failure case.

11. The computerized method of claim 9, wherein said defined algebraic function approximating said at least one functional failure case probability is a sum of said components' failure probabilities in power of one plus said degree of components' redundancies.

12. The computerized method of claim 1, wherein said defining at least one functional failure case includes receiving safety requirements comprising said at least functional failure case and a maximum allowed probability for said at least one functional failure case.

13. The computerized method of claim 12, wherein said received safety requirement is a textual safety requirement.

14. The computerized method of claim 1, wherein said architecture is selected from the group consisting of: automotive systems, airspace and defense systems, safety critical systems, medical systems, model based systems, and combinations thereof.

15. A computerized method for automatic architecture generation, comprising:
receiving a functional description of an architecture of a system, said functional description comprising a plurality of implemented functions and a plurality of functional links between said plurality of implemented functions;
Receiving safety requirements comprising a plurality of functional failure cases and maximum allowed failure probabilities for said plurality of functional failure cases and defining a system of algebraic constraints;
generating a set of equations of algebraic failure probabilities using an algebraic function approximating the probability of occurrence of said plurality of functional failure cases and said system of algebraic constraints;
automatically generating an architecture having approximated failure probabilities which are smaller than said maximum allowed failure probabilities using an optimization solver that solves said set of equations; and
Outputting said automatically generated architecture.

16. A system for automatic architecture generation, the system comprising:
an input interface which receives a functional description of an architecture of a system, said functional description comprising a plurality of functions and a plurality of functional links between said plurality of functions and safety requirements comprising at least one maximum allowed failure probability;
a storage medium for storing said received functional description, said safety requirements and a program code; and
a processor for executing said program code, wherein said processor is programmed to receive said functional description of an architecture, to calculate an algebraic function approximating the probability of occurrence of at least one failure case, to automatically generate an architecture having an approximated failure probability which is smaller than said maximum allowed at least one failure probability using said algebraic function and to output said generated architecture.

17. The system of claim 16, wherein said processor is programmed to generate automatically said architecture using a MILP optimization solver.

18. A computer program product for automatic architecture generation, the computer program product comprising:
a computer readable storage medium;
first program instructions to receive a functional description of an architecture of a system, said functional description comprising a plurality of functions and a plurality of functional links between said plurality of functions and safety requirements comprising a maximum allowed failure probability of at least one functional failure case;
second program instructions to define an algebraic function approximating the probability of occurrence of said at least one failure case and a system of algebraic constraints and to generate a set of equations of algebraic failure probabilities using said algebraic function and said system of algebraic constraints; and
third program instructions to automatically generate an architecture using an optimization solver program code, wherein said architecture's at least one approximated failure probability is smaller than said maximum allowed probability and to output said generated architecture,
Wherein said program instructions are stored on said computer readable storage medium.

19. The computer program product of claim 18, wherein said optimization solver program code is a MILP optimization solver program code.

20. The computer program product of claim 18, wherein said second program instructions further comprising instructions to calculate said algebraic function, said algebraic function is a function of a plurality of failure probabilities of said plurality of components and of the degree of redundancies of said components for said at least one functional failure case, wherein said degree of redundancies of components are calculated as the minimum number of paths bypassing said components performing said at least one functional failure case.
